(19) United States
(12) Patent Application Publication
(10) Pub. No.: US 2008/0317077 A1
(43) Pub. Date: Dec. 25, 2008

(54) Device and Method for Laser Safe Operation

(75) Inventors: Willem Hoving, Geldrop (NL); Toon A.H. Kop, Oosterhout (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,347

(22) PCT Filed: Dec. 8, 2006
(86) PCT No.: PCT/IB06/54706

§ 371 Date: Jun. 13, 2008

Related U.S. Application Data
(60) Provisional application No. 60/749,804, filed on Dec. 13, 2005.

(51) Int. Cl. H01S 3/13

(52) U.S. Cl. 372/29.01

(57) ABSTRACT

A laser system (100) produces at least one laser beam (204) that is output from the laser system. The laser system includes a safety device (124) that terminates the output of the laser beam from the laser system. The termination occurs upon the laser beam interacting with a predetermined reflective surface (202) to change a characteristic thereof, thus indicating of a fault condition where the laser beam may cause damage to a human eye, for example. The safety device (124) may be reflective in the path of the laser beam(s) from source to output, and the reflective surface (202) melts or ablates upon the fault condition, thus interrupting the path and preventing laser output. In addition, the safety device (124), upon the fault condition, may produce or trigger a control signal (126) to turn off the laser sources (110). A sensor (620) may be located behind the predetermined surface (202) to indicate the fault condition upon ablation and/or melting of the predetermined surface (202).

The present invention relates to laser systems, and, in particular, relates to laser devices that project laser beams beyond the device that may be hazardous to user, viewers and others, and, in greater particularity, relates to laser projectors.

The presentation of full color images on a screen, for example, by a laser projector requires complex electronic and optical technology and, further presents significant safety issues.

One version of a light modulator projector uses scanning devices where multiple laser beams are very rapidly scanned on a screen to create an image. This is similar to the process of scanning an electron beam across a CRT, but has limitations due to the optical systems components such as the polygon scanner and the galvo mirror required to move the laser beams in the X-Y directions on the screen to illuminate each of the defined pixels on the screen. In order to increase the quality of the image, multi-beam scanning has been suggested and is disclosed in U.S. Pat. No. 6,351,324, which is incorporated herein by reference in its entirety.

In order to produce sharp, clear and bright images with laser beams from projectors, intense laser beams are required which can injure eyes. In order to produce safe laser devices, precautions must be taken in the design of such devices. U.S. Pat. No. 5,665,942, which is incorporated herein by reference in its entirety, discloses an optical-scanning system that reduces the effective power of the laser beam during the scanning process, monitors the laser's “sleeping” period for proper output, and further shut downs if certain devices such as the scanner motor or the scanner speed are not within defined ranges.

U.S. Pat. No. 6,913,603, which is incorporated herein by reference in its entirety, discloses a laser eye surgery system where a fraction of the laser energy is taken from the laser beam for diagnostic testing, and if not within specifications, a computer unit will stop the laser beam. This safety system does not provide an independent assessment of the full laser beam and relies on computer analysis of the laser operation.

U.S. Patent Application Publication No. 2005/0007562, which is incorporated herein by reference in its entirety, discloses a laser safety system for use in a laser projector where a galvo mirror is forced by means of magnets into a defined position to stop the output of the laser beam when there is a scanning failure. The laser beam is directed into a shielding unit to stop the output until the laser is turned off.

U.S. Patent Application Publication No. 2005/0024704, which is incorporated herein by reference in its entirety, discloses the use of an angle sensor on the scanner and a control block unit to determine if there is a fault condition and then directs the laser beam into a protective sphere and blocks the output laser beam with mechanical shutters.

U.S. Patent Application Publication Nos. 2005/0035943 and 2005/0128578, which are incorporated herein by reference in their entirety, disclose the use of a laser safety system employing infrared detection, for example, to detect the presence of an object in the path of the laser beam between the projector and the screen, and then subsequently reduce the beam intensity to a safe level. These references fail to consider the laser beam being improperly directed or failing to operate as required.

Thus, there exists a need for a device that allows for the immediate termination of laser beams from image projectors upon the failure of the scanner or other devices within the system.

Accordingly, a laser system is provided such as an image projector using laser beams. Upon a fault condition, the laser beams are terminated to prevent possible damage to human eyes of the user and/or viewers of the image or other persons in the immediate area. The laser system, such as an image projector for example, outputs one or more laser beams that may be terminated upon a fault condition, such as the failure of the scanner, for example. The laser system includes a predetermined surface upon which the one or more laser beams interact upon the fault condition to terminate the output laser beams. Illustratively, the one or more laser beams may interact with the predetermined surface by ablating and/or melting the surface upon the fault condition to terminate the output laser beams.

The laser system produces one or more laser beams that are output from the laser system. The laser system includes means for terminating the output of the one or more laser beams from the laser system upon the occurrence of the one or more laser beams interacting with the predetermined surface to change a characteristic of the predetermined surface indicative of a fault condition, when the one or more laser beams may cause damage to a human eye. The predetermined surface upon interaction with the one or more laser beams may ablate and/or melt to indicate the fault condition. A sensor may further be located behind the predetermined surface to sense and indicate the fault condition upon ablation of the predetermined surface, in response to which a control signal may be sent to the laser source(s) for shut-down. The means for terminating may operate independent of the optical system for outputting the one or more laser beams.

Further features and advantages of the present invention will be readily apparent to one skilled in the pertinent art from the following detailed description provided hereinafter, and accompanying drawings where:

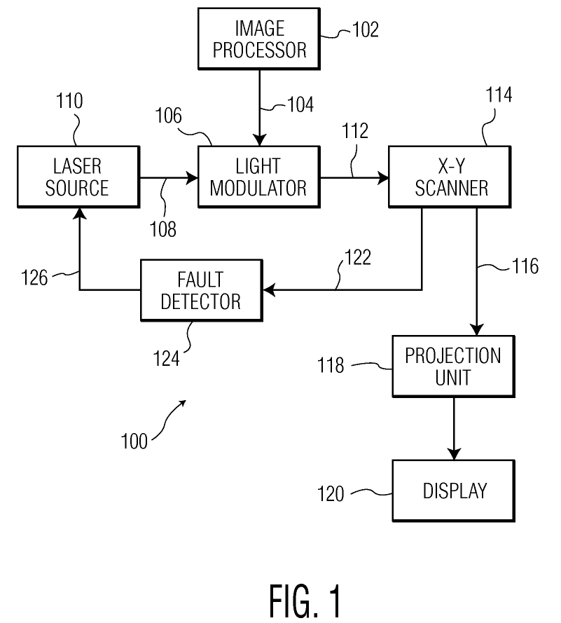

FIG. 1 illustrates a schematic block diagram of one embodiment of a laser system according to the present invention representing a scanning laser projector where a fault detector means is connected between the scanner and the laser;

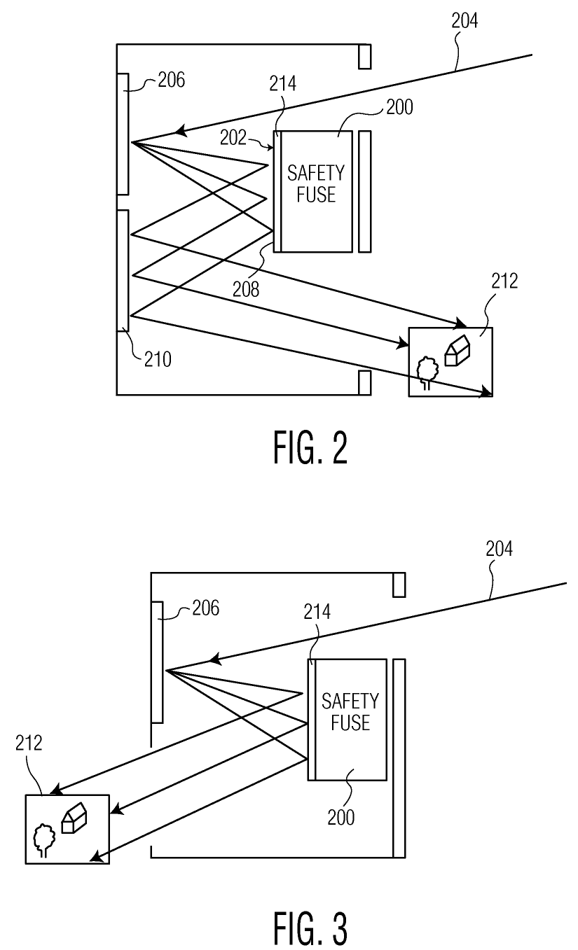

FIG. 2 is a partial schematic representation of the optical train wherein the means to terminate the output acts independently of the optical train;

FIG. 3 is a partial schematic representation of the optical train wherein the means to terminate the output acts as a part of the optical train;

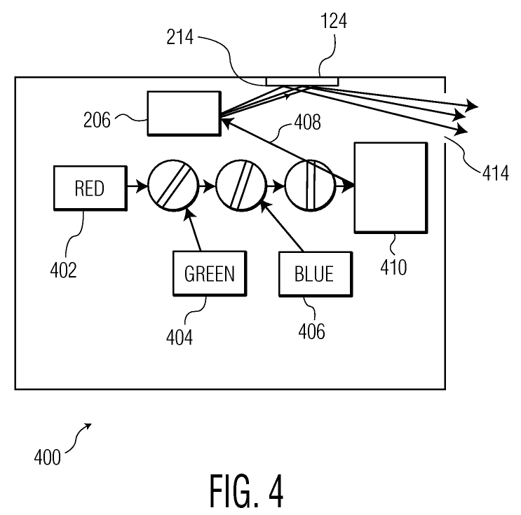

FIG. 4 is a partial schematic representation of a laser source, a light modulator, and a scanner according to one embodiment of the present invention;

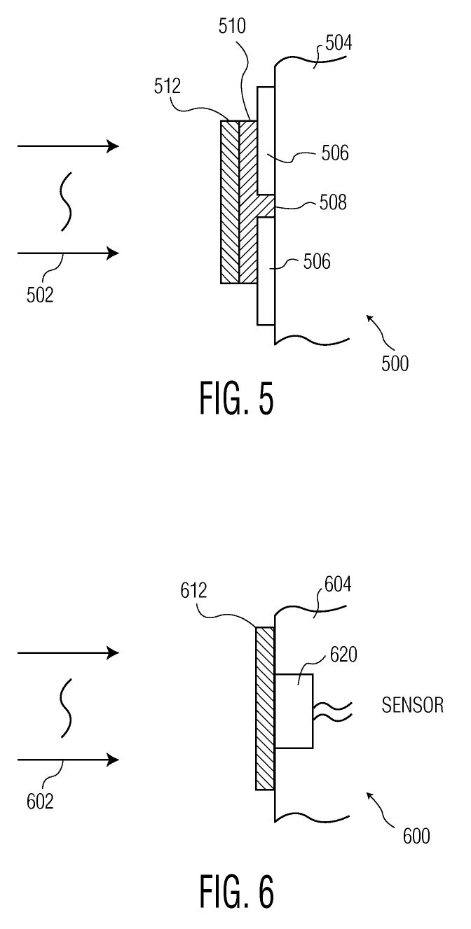

FIG. 5 is a partial cross-sectional view of one embodiment of the present invention being a means to terminate the output of the laser beam such as an ablatable surface and/or meltable surface for indicating a fault condition;

FIG. 6 is a partial cross-sectional view of another embodiment of the present invention being a means to terminate the output of the laser beam being an ablatable surface having a light sensor behind the surface for indicating a fault condition;

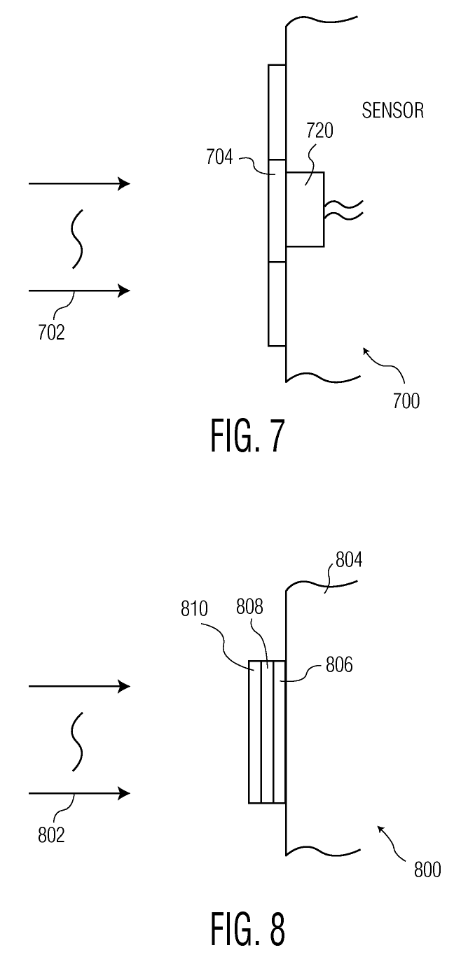

FIG. 7 is a partial cross-sectional view of another embodiment of the present invention being a means to terminate the output of the laser beam being a mirrored ablatable surface;

FIG. 8 is a partial cross-sectional view of another embodiment of the present invention being a means to terminate the output of the laser beam being two conductive layers separated by a non-conductive layer for indicating a fault condition;

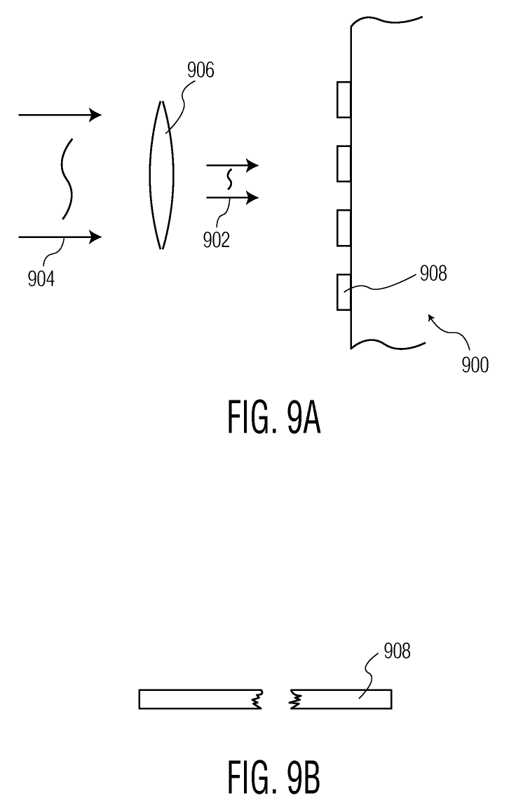

FIG. 9A is a partial cross-sectional view of another embodiment of the present invention being a means to terminate the output of the laser beam being a plurality of parallel ablatable conductive strips for indicating a fault condition; and

FIG. 9B illustrates one of the ablatable conductive strips of FIG. 9A having an open condition therein caused by a laser beam.

It should be understood that the detailed description and specific examples, while indicating exemplary embodiments of the invention, are intended for purposes of illustration only and are not intended to limit the scope of the invention.

Referring to FIG. 1, a block diagram of a laser system 100 such as a scanning laser projector is shown. The laser system 100 generates a two dimensional color image on a screen 120. The image data is transformed in an image processing unit 102 which includes such devices as a video processor and drivers that are well known. A video signal 104 from the image processing unit 102 controls the operation of a light modulator unit 106 which may use electro-optic modulators or acousto-optic modulators that operate on one or more laser beams 108 from a laser source 110. The laser source 110 has multiple lasers, for example, diode laser-pumped solid-state lasers, to output red, green and blue laser beams 108. These laser beams are input into the light modulator 106 that modulates the laser beams in response to the video signal 104. The modulated laser beams 112 from the light modulator 106 are input into a scanner 114, such as an x-y scanner for example, which includes therein a vertical scanner and a horizontal scanner that are well know. The x-y scanner 114 outputs a horizontally and vertically scanned laser beams 116 into a projection unit 118 that then outputs appropriate RGB laser beams to generate a scanned image on the screen 120.

An internal laser beam 122 being one or more of the scanned laser beams 116 within the x-y scanner 114 is used to determine if the lasers in the laser source 110 should be turned off, or the output beam(s) interrupted, until a cause of a fault condition generated in a fault detector 124 is repaired. The fault detector 124 continually outputs a fault signal 126 being either a 1 or a 0, for example, representing a “no fault” condition or a “fault” condition, respectively. Alternatively, only a control signal indicative of the fault condition may be output when fault is detected to turn off the laser source(s) 110. The electronics necessary for implementing this fault detector 126 and its operation are well known and may include switches and relays, for example, as describe in the above-mentioned U.S. Pat. No. 6,351,324.

FIG. 2 is a partial schematic illustration of the means for terminating the laser output being a laser safety fuse 200, wherein the laser safety fuse 200 is not an integral part of the optical train of the x-y scanner and/or the projection unit. As seen in FIG. 2, the laser safety fuse 200 has a predetermined surface 202 which acts as a mirror in the optical train, or it may be a non-mirrored surface as to be described later. During normal operation, an RBG laser beam 204 reflects off of a scanning mirror 206 and further reflects off of the mirrored predetermined surface 202. The beam 204 will scan across the predetermined surface 202 following a line 208, for example, reflect off another mirror 210 onto a screen (shown as reference 120 in FIG. 1) to form an image 212.

If the laser beam 204 slows or stops along the line 208, a sufficient amount of fluence of laser energy will interact with the surface 202 to cause a condition thereon which would indicate a fault condition such as a scanner failure. It is further an option if the scanning mirror 206 (which is part of the scanner 114 shown in FIG. 1) fails, the reflected beam 204 will fall on a default position along the line 208. The coating material 214 of the surface 202 is reflective and also degradable in response to the laser beam of a predetermined energy on impinging on the surface coating 214 for a predetermined duration, e.g., when the scanning mirror 206 fails to scan properly. Such a coating 214 may be prepared by depositing a thin layer of metallic material such as silver, gold, or other types of metals that would ablate and/or melt under an intense laser beam of sufficient/desired duration and intensity.

It is a further embodiment where the laser safety fuse is not an integral part of the optical train but still receives a scanned laser beam, for example, in a default position where the scanner stops if defective. In this embodiment, the predetermined surface need not be reflective as will be described hereinafter, but will detect the fault condition and send a control signal 126 to shut off the laser source(s) 110 shown in FIG. 1.

FIG. 3 illustrates an embodiment 300 where the laser beam 204 reflects off of the scanning mirror 206 onto and from the reflective coating 214 being an integral part of the optical train and then onto a screen to form the image 212. That is, the mirror 210 shown in FIG. 2 is eliminated in the embodiment shown in FIG. 3.

FIG. 4 partially illustrates a laser projector 400 having three colored lasers, a Red laser source 402, a Green laser source 404 and a Blue laser source 406 outputting appropriate beams being combined into a single RGB beam 408. The RGB beam 408 is scanned by a rotating polygon scanner 410, for example, typically in the x-direction of the image, horizontally, and a galvo mirror 206, typically in the y-direction, vertically. The fault detector 124, which may include the reflective coated surface 214, reflects the beams through an output window 414 onto the screen 120 (FIG. 1).

FIGS. 5 to 9A illustrate different embodiments of the fault detector devices 124 (FIGS. 1 and 4), which need not have reflective surface and are located to receive representative laser beam(s) from the laser beam(s) from the galvo mirror 206, and/or from the rotating polygon scanner 410 shown in FIG. 4, and send the control signal 126 to shut off the laser source(s) 110 (shown in FIG. 1) in response to detection of the fault condition. The representative laser beam(s) received by such non-reflective fault detector devices mimic the scanning action of the laser beam(s) that are eventually output from the laser projection system to form the image 212 on an external surface 120 (FIG. 1). Thus, when the output beam(s) fail to scan, so will the representative laser beam(s), which failure will be detected by the non-reflective fault detector devices to shut off the laser sources as will be described.

The fault detector devices shown in FIGS. 5 to 9A, which may have non-reflective surfaces, include various thin films. The deposition of thin films is well known in the art and further the ability to create patterns in these films is also well known in the art of semi-conductor fabrication and considered conventional. Any desired material can be used for the thin films where laser beams both continuous (CW) and pulsed can ablate and/or melt these films once exposed to a laser beams for a desired duration and intensity. For example, a laser beam spot size in the range of from about 1 to 100 micrometers (microns), with a fluence (J/sq. cm.) of from about 0.01 to about 100, and with pulse energies from 100 nJ to 100 microJ will ablate ceramic, polymer and metal films in certain ranges. The type of such material and thickness thereof are known to one skilled in the art of semiconductor fabrication and metallurgy.

Further, the input beam on the predetermined surface is not necessarily the same diameter as the laser beam passing through the scanner because optical elements may be added to focus more sharply the laser beams on the predetermined surfaces to be disclosed. See FIG. 9A, for example. The following devices may be located at either end of the scan line and have shapes such a dots, squares, and rectangles.

If there are deficiencies in either the scanner 410 or galvo mirror 206, the representative laser beam will be positioned in a default position at the end of the scan line or in another predetermined position until the problem is repaired. Once the representative laser beam is positioned at the default position, e.g., when scanning stops or fails to perform as desired, a control signal form the fault detector will shut off the laser sources. This safety feature of shutting off the laser sources may be in lieu of or in addition to preventing reflections from the safety coating 214 upon melting thereof for example, thus preventing exit of laser beams out of the window 414. Of course, instead of using representative beams and non-reflective fault detectors, the fault detectors may be reflective and situated in the output path to receive the actual beams (instead of the representative beams) for reflection output from the laser projector during proper operation.

The fault detector devices shown in FIGS. 5-9A are mounted, for example, on small chips such as semiconductor chips and can be removed once they are triggered to send a terminate signal to the laser source. The fault detector 124 and the reflective or non-reflective safety coating 214 may be an integrated unit or separate units. If separate units, upon failure and destruction, e.g., melting, of the safety coating unit, it can easily be replaced with a new unit having the safety coating 214 with none or minimal alignment. If the safety coating surface of the fault detector device has a mirrored surface that functions in the scanner unit, this may require a finer alignment upon replacement.

Referring to FIG. 5, a fault detector device 500 is shown in a cross sectional view having an input laser beam 502 coming from the left. A chip base 504 has a pair of separated conductors 506 which are wired into a switch or control input of the laser source(s) 110 (FIG. 1). A gap 508 between the conductors 506 is filled with a first layer 510 as well as being over the conductors 506. The first layer 510 is a non-conducting material. A second layer 512 being made of a conductive material is placed on top of the first layer 510. When the laser beam 502 falls upon the safety surface being the second layer 512 for a sufficient time, the second layer 512 will heat up and eventually ablate and/or melt along with the first layer 510. The first layer 510 need not be a continuous layer or a layer that completely covers the pair of conductors 506. For example, posts on non-conductive layers may be dispersed between the pair of conductors 506 and the second conductive layer 512 for separation thereof, until the non-conductive posts and the second conductive layer 512 melt.

Such melting will cause an electrical short between the ends of the conductors 506 and will cause the laser source to terminate the lasers, e.g., via issuance of a control signal as is well known to one skilled in the electrical art. Of course in the case the safety coating is reflective and the safety device is situated in the path of the output beams, the laser sources need not be turned off and yet safety is still ensured, since once the reflective safety coating ablate and/or melt, the laser beams cannot exit the window 414 (FIG. 4) and thus will not pose a danger to any viewers.

Referring to FIG. 6, another embodiment of the fault detector device 600 is shown. As seen therein, a chip base 604 has an ablatable first layer 612 applied thereon. Under the first layer 612 is positioned a laser beam sensor 620. When the laser beam 602 impacts on the first layer 612, it will ablate and expose the laser beam sensor 620 to the laser beam 602. This will again cause a condition, such as a short condition for example, to occur in the sensor which may trigger a control signal will terminate the lasers in the laser sources.

FIG. 7 illustrates the embodiment where the fault detector device 700 has a mirrored surface 704. With sufficient fluence, the mirrored surface with ablate and expose the laser beam sensor 720 thereunder to the laser beam 702, thus triggering the control signal to terminate the lasers in the laser sources.

FIG. 8 illustrates an embodiment of a fault detector device 800 having three layers 806, 808, and 810 to form a capacitor like device. The top and bottom layers 806 and 810 are conductive and attached to electrical wires. The middle layer 808 is non-conductive. Upon a sufficient fluence from laser beam 802, the middle layer 880 will melt (as well as the top layer 810 as desired) resulting in a short condition between the top and bottom layers.

FIG. 9A discloses an embodiment of the fault detector device 900 where there are a plurality of parallel metal strips 908. The input laser beam 904 is further focused by a lens element 906 to reduce the diameter of the laser beam 904 to a reduced diameter laser beam 902. The greater fluence will further aid in the ablation of a portion of the strip 908 as shown in FIG. 9B. The open condition will be detected and cause the laser Sources to terminate the lasers.

As seen in the above embodiments, a laser safety fuse is provided that will immediately result in the termination of the lasers or termination of the output beams thus preventing such output beams from leaving the laser projector. The laser safety fuses provide an independent means to terminate the lasers and/or output beams upon any conditions that cause the laser scanners to be positioned in a default position. This will insure that the laser beams do not exit from the projector in any form to damage eyes of viewers for example.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A laser system (100) that produces one or more laser beams, said one or more laser beams being output from said laser system (100), wherein said laser system (100) comprises:
a safety device (124) configured to terminate the output of said one or more laser beams from said laser system (100), said terminating occurring upon said one or more laser beams interacting with a predetermined surface (202) to change a characteristic of said predetermined surface (202) indicative of a fault condition.

2. The laser system (100) according to claim 1, wherein said safety device (124) operates independent of an optical system for outputting said one or more laser beams.

3. The laser system (100) of claim 1, wherein said predetermined surface (202) upon interaction with said one or more laser beams ablates and/or melts to indicate said fault condition.

4. The laser system (100) of claim 1, further comprising a sensor (620) located behind said predetermined surface to indicate said fault condition upon ablation of said predetermined surface (202).

5. The laser system (100) of claim 1, wherein said predetermined surface (202) is reflective.

6. The laser system (100) of claim 1, wherein said predetermined surface (202) comprises two conductive coatings (506, 512) separated by a non-conductive layer (510), said fault condition occurring when said one or more laser beams causes a short condition between said two conductive coatings (506, 512).

7. The laser system (100) of claim 1, wherein said predetermined surface (202) comprises a plurality of conducting strips (908) thereon, said default condition occurring when said one or more laser beams causes an open condition in one or more of said strips (908).

8. The laser system (100) of claim 1, wherein said predetermined surface (202) is configured to be removable from said laser system after the occurrence of said fault condition and replaceable to reset said safety device (124).

9. The laser system (100) of claim 1, further comprising a scanner (114) configured to scan said one or more laser beams upon an external surface (120), wherein said fault condition occurs upon a failure of said scanner (114).

10. A method of operating a laser system (100), comprising the acts of:
producing one or more laser beams for forming output beams exiting from said laser device; and
terminating said output beams upon said one or more laser beams interacting with a predetermined surface (202) to change a characteristic of said predetermined surface indicative of a fault condition.

11. The method of claim 10, wherein said predetermined surface (202) upon interaction with said one or more laser beams ablates and/or melts to indicate said fault condition.

12. The method of claim 10, further comprising a sensor (620) located behind said predetermined surface to indicate said fault condition upon ablation of said predetermined surface (202).

13. The method of claim 10, wherein said predetermined surface (202) is reflective.

14. The method of claim 10, wherein said predetermined surface (202) comprises two conductive coatings (506, 512) separated by a non-conductive layer (510), said fault condition occurring when said one or more laser beams causes a short condition between said two conductive coatings (506, 512).

15. The method of claim 10, wherein said predetermined surface (202) comprises a plurality of conducting strips (908) thereon, said default condition occurring when said one or more laser beams causes an open condition in one or more of said strips (908).

16. The method of claim 10, wherein said predetermined surface (202) is configured to be removable from said laser system (100) after the occurrence of said fault condition and replaceable to reset said safety device (124).

17. The method of claim 10, further comprising the act of scanning scan said one or more laser beams upon an external surface (120), wherein said fault condition occurs upon a failure of said scanning act.

18. A laser system (100) that produces one or more laser beams, said one or more laser beams being output from said laser system, wherein said laser system comprises:
means for producing (110) said one or more laser beams for forming output beams exiting from said laser device; and
means for terminating (124) said output beams upon said one or more laser beams interacting with a predetermined surface (202) to change a characteristic of said predetermined surface (202) indicative of a fault condition.

19. The laser system (100) of claim 18, wherein said predetermined surface (202) upon interaction with said one or more laser beams ablates and/or melts to indicate said fault condition.

20. The laser system (100) of claim 18, further comprising a sensor (620) located behind said predetermined surface (202) to indicate said fault condition upon ablation of said predetermined surface (202).
